(19) United States
(12) Patent Application Publication
(10) Pub. No.: US 2016/0153638 A1
(43) Pub. Date: Jun. 2, 2016

(54) OPTICAL PRISM SHEET

(71) Applicant: OPTIVISION TECHNOLOGY INC.

(72) Inventors: Kuang-Lin Yuan, Taichung City (TW); Li-Jen Hsu, Yilan County (TW); Chun-Ming Hsu, Yunlin County (TW); Wei-Chun Peng, Miaoli County (TW)

(73) Assignee: OPTIVISION TECHNOLOGY INC.

(21) Appl. No.: 14/630,650

(22) Filed: Feb. 25, 2015

(30) Foreign Application Priority Data
Dec. 2, 2014 (TW) 103221323

(51) Int. Cl. F21V 5/00

(52) U.S. Cl. CPC F21V 5/005

(57) ABSTRACT

An optical prism sheet includes a transparent substrate having a light-entrance surface, and a plurality of elongated prisms that protrude from the transparent substrate. Each of the prisms has a scalene triangular cross-section and first and second surfaces that intersect each other to define an apex angle. The apex angle of each of the prisms is divided by a normal line of the transparent substrate into first and second sub-angles that are different from each other. At least one of the light-entrance surface and the first and second surfaces of each of the prisms is roughened to form a plurality of micro-protrusions, each of which has a height ranging from 0.1 μm to 5 μm.

### CROSS-REFERENCE TO RELATED APPLICATION

This application claims priority of Taiwanese Application No. 103221323, filed on Dec. 2, 2014.

### FIELD

This invention relates to an optical prism sheet, more particularly to an optical prism sheet including a plurality of prisms, each of which has a scalene triangular cross-section.

### BACKGROUND

FIG. 1 illustrates a conventional backlight module that includes a light guide plate 1, two light sources 2 disposed respectively at two opposite lateral sides of the light guide plate 1, two reflective covers 3 covering respectively the light sources 2, a reflector sheet 4 disposed at a bottom side of the light guide plate 1 and an optical diffuser assembly 5 disposed at an upper side of the light guide plate 1. The optical diffuser assembly 5 includes a bottom diffuser 51, a lower prism sheet 52, an upper prism sheet 53, and a top diffuser 54, which are stacked one above another. In operation, light emitted from the light sources 2 passes through and is guided by the light guide plate 1 into and through the bottom diffuser 51, the lower prism sheet 52, the upper prism sheet 53 and the top diffuser 54. The lower prism sheet 52 and the upper prism sheet 53 function to concentrate the light passing therethrough and to limit the light exiting the lower prism sheet 52 and the upper prism sheet 53 to an angle within predetermined ranges, respectively.

The conventional optical diffuser assembly 5 is likely to have observable defects caused by Wet-out and Moiré effects and/or scratches formed during assembly of the optical diffuser assembly 5. The Wet-out effect occurs when two surfaces of two different optical films are stacked one above the other, thus effectively removing the change in refractive index for light propagating from one of the optical films to the other of the optical films, which causes varying appearance over the optical diffuser assembly 5. The Moiré effect is caused by optical interference, and occurs when two prisms are stacked one above the other and are perpendicularly aligned with each other. In addition, the optical diffuser assembly 5 has a relatively large overall thickness due to the combination of the bottom diffuser 51, the lower prism sheet 52, the upper prism sheet 53, and the top diffuser 54.

### SUMMARY

Therefore, an object of the present disclosure is to provide an optical prism sheet that can overcome at least one of the aforesaid drawbacks associated with the prior art.

According to this disclosure, there is provided an optical prism sheet that includes a transparent substrate having a light-entrance surface; and a plurality of elongated prisms that are disposed at one side of the transparent substrate opposite to the light-entrance surface, that protrude from the transparent substrate in a direction away from the light-entrance surface, and that are substantially parallel to one another. Each of the prisms has a scalene triangular cross-section and first and second surfaces that intersect each other to define an apex angle which is opposite to and faces toward the transparent substrate. The apex angle of each of the prisms is divided by a normal line of the transparent substrate into first and second sub-angles that are different from each other. At least one of the light-entrance surface and the first and second surfaces of each of the prisms is roughened to form a plurality of micro-protrusions, each of which has a height ranging from 0.1 μm to 5 μm.

### BRIEF DESCRIPTION OF THE DRAWINGS

In drawings which illustrate embodiments of the disclosure,

FIG. 1 is a schematic view of a conventional backlight module;

FIG. 2 is a fragmentary perspective view of the first embodiment of an optical prism sheet according to the disclosure;

FIG. 3 is a schematic view of the first embodiment;

FIG. 4 is an electron microscope image of a roughened surface of an elongated prism of the first embodiment;

FIG. 5 is a fragmentary schematic view showing the configuration of micro-protrusions of the roughened surface of the elongated prism of the first embodiment;

FIG. 6 is a fragmentary schematic view of the second embodiment of the optical prism sheet according to the disclosure;

FIG. 7 is a fragmentary schematic view of the third embodiment of the optical prism sheet according to the disclosure; and

FIG. 8 is a fragmentary perspective view of a backlight module including the first embodiment.

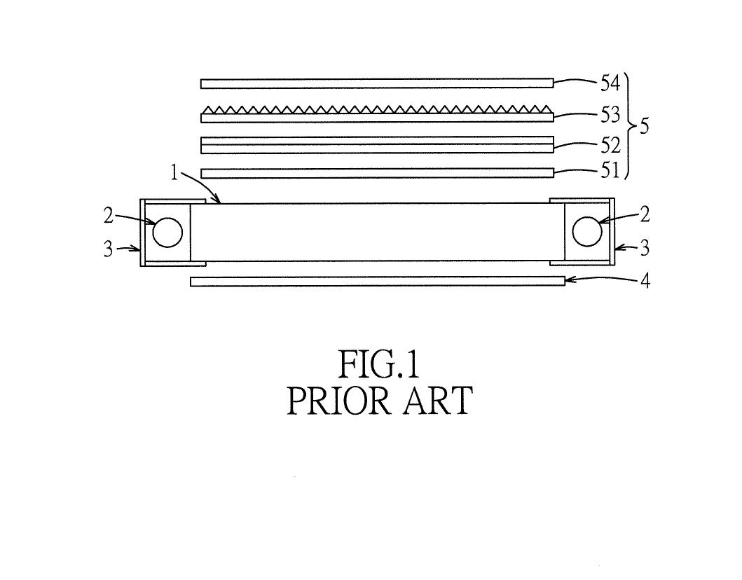

### DETAILED DESCRIPTION

Before the present disclosure is described in greater detail with reference to the accompanying exemplary embodiments, it should be noted herein that like elements are denoted by the same reference numerals throughout the disclosure.

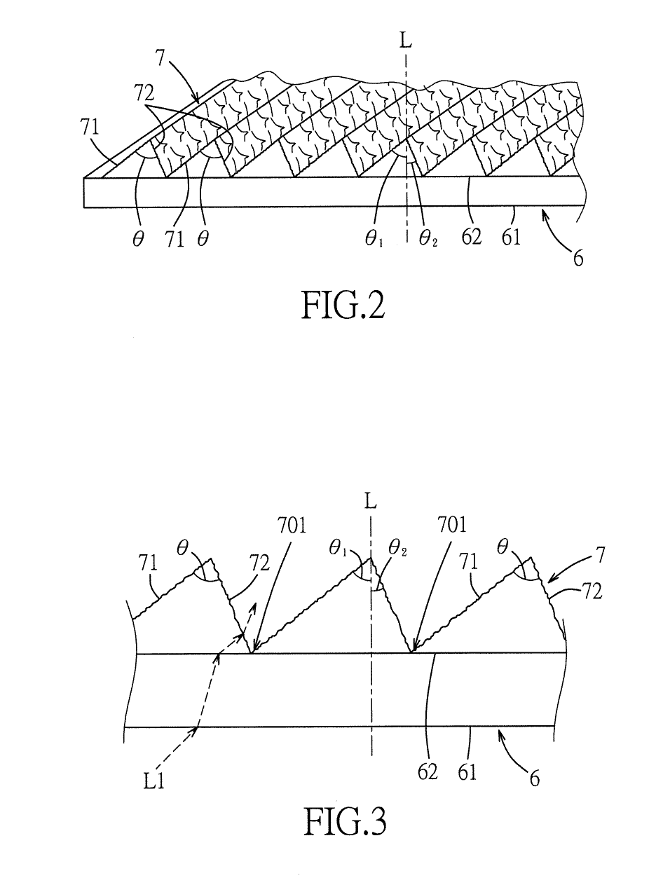

FIGS. 2 to 5 illustrate the first embodiment of an optical prism sheet according to the present disclosure. The optical prism sheet includes a transparent substrate 6 and a plurality of elongated (rod- or bar-shaped) prisms 7.

The transparent substrate 6 has a light-entrance surface 61 and a light-exit surface 62 opposite to the light-entrance surface 61, is flexible, and may be made from a polymeric material, such as polyethylene terephthalate (PET), polyethylene naphthalate (PEN), and polycarbonate (PC). In this embodiment, the light-entrance surface 61 is flat and smooth.

The prisms 7 may be made from a material, such as UV-cured resin, are disposed at one side of the transparent substrate 6 (in this embodiment, the one side is the light-exit surface 62) opposite to the light-entrance surface 61, protrude upwardly from the light-exit surface 62 of the transparent substrate 6 in a direction away from the light-entrance surface 61, and are substantially parallel to one another. The prisms 7 may be attached to the transparent substrate 6 or integrally formed with the transparent substrate 6. The UV-cured resin may have a refractive index ranging from 1.45 to 1.62.

Each of the prisms 7 has a scalene triangular cross-section and first and second surfaces 71, 72 that intersect each other to define an apex angle (θ) which is opposite to and faces toward the light-exit surface 62 of the transparent substrate 6. The apex angle (θ) of each of the prisms 7 is divided by a normal line (L) of the transparent substrate 6 into first and second sub-angles (θ₁, θ₂) that are different from each other. Each of the first and second sub-angles (θ₁, θ₂) ranges from 10 degrees to 50 degrees, so that light ray (L1) entering the light-entrance surface 61 with an incident angle ranging from 40 degrees to 80 degrees relative to the normal line (L) of the transparent substrate 6 may be refracted out from the first and second surfaces 71, 72 with an exit angle ranging from −50 degrees to +50 degrees relative to the normal line (L) of the transparent substrate 6.

In this embodiment, the first sub-angles (θ₁) of the prisms 7 are larger than the second sub-angles (θ₂) of the prisms 7.

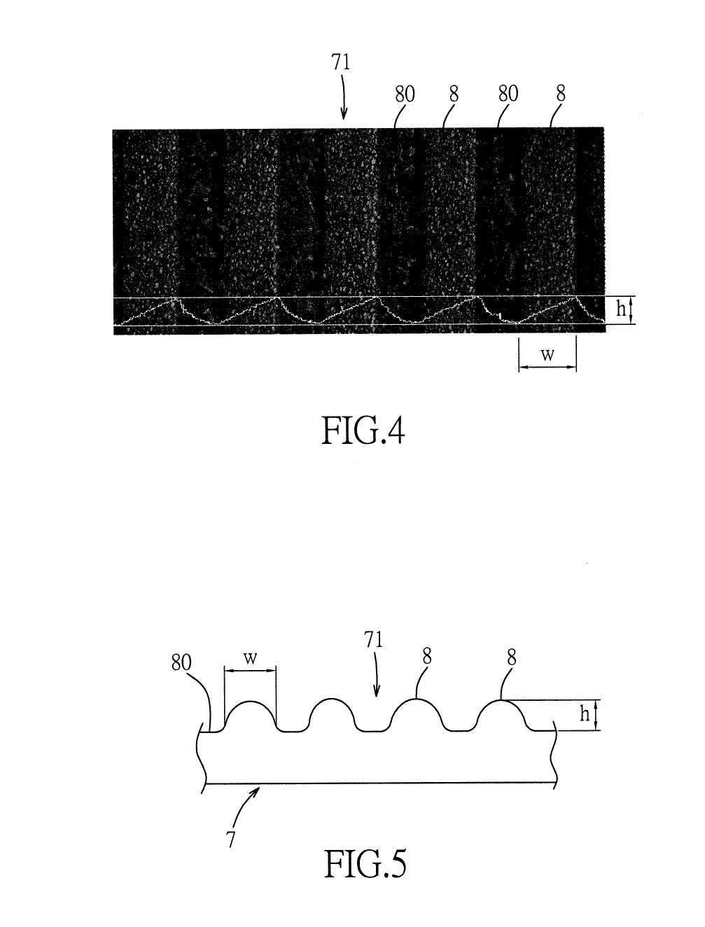

At least one of the light-entrance surface 61 and the first and second surfaces 71, 72 of each of the prisms 7 is roughened to form a bed region 80 and a plurality of micro-protrusions 8 that protrude outwardly from the bed region 80 (see FIG. 5 with reference to FIG. 4, only the first surface 71 is shown in FIG. 5 to illustrate the configuration of the micro-protrusions 8 with respect to the bed region 80 for the sake of brevity). Each of the micro-protrusions 8 has a height (h) (relative to the bed region 80 of the at least one of the light-entrance surface 61 and the first and second surfaces 71, 72 of each of the prisms 7) ranging from 0.1 μm to 5 μm, so that the micro-protrusions 8 of the at least one of the light-entrance surface 61 and the first and second surfaces 71, 72 of each of the prisms 7 may reduce the aforesaid observable defects caused by the Wet-out and Moiré effects. Each of the micro-protrusions 8 may have a micron-scale width (w).

In this embodiment, the first and second surfaces 71, 72 of each of the prisms 7 are roughened and are formed with the micro-protrusions 8.

The first surfaces 71 of the prisms 7 are parallel to one another, and the second surfaces 72 of the prisms 7 are parallel to one another. The apex angles (θ) of the prisms 7 are equal.

In this embodiment, the second surface 72 of one of every two adjacent ones of the prisms 7 and the first surface 71 of the other of the every two adjacent ones of the prisms 7 are connected to each other to form a V-shaped valley 701.

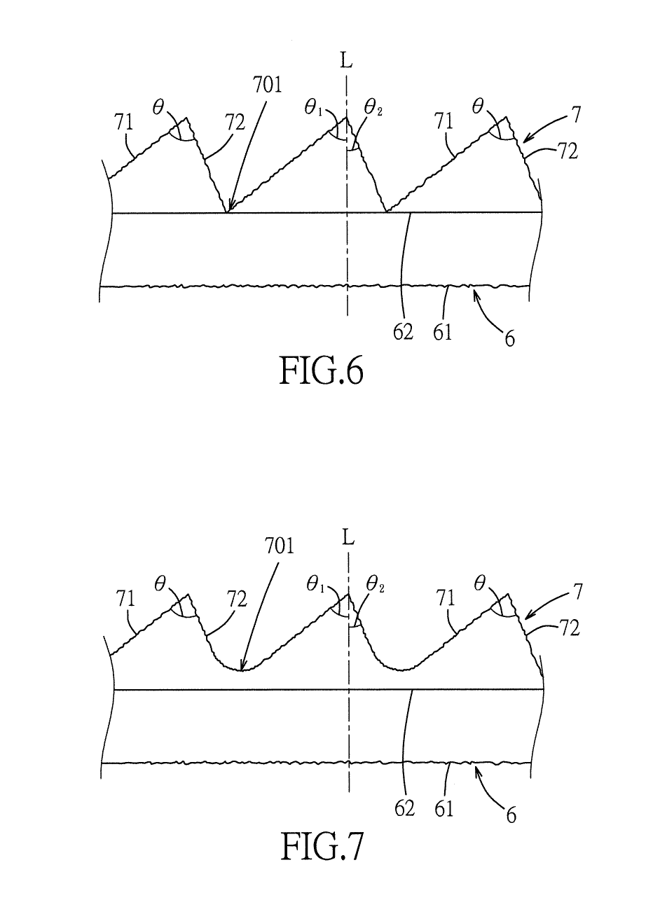

FIG. 6 illustrates the second embodiment of the optical prism sheet according to the present disclosure. The second embodiment differs from the previous embodiment in that the light-entrance surface 61 is also roughened to form a plurality of the micro-protrusions 8.

FIG. 7 illustrates the third embodiment of the optical prism sheet according to the present disclosure. The third embodiment differs from the previous embodiments in that the second surface 72 of one of every two adjacent ones of the prisms 7 and the first surface 71 of the other of the every two adjacent ones of the prisms 7 are connected to each other to form a U-shaped concave valley 701.

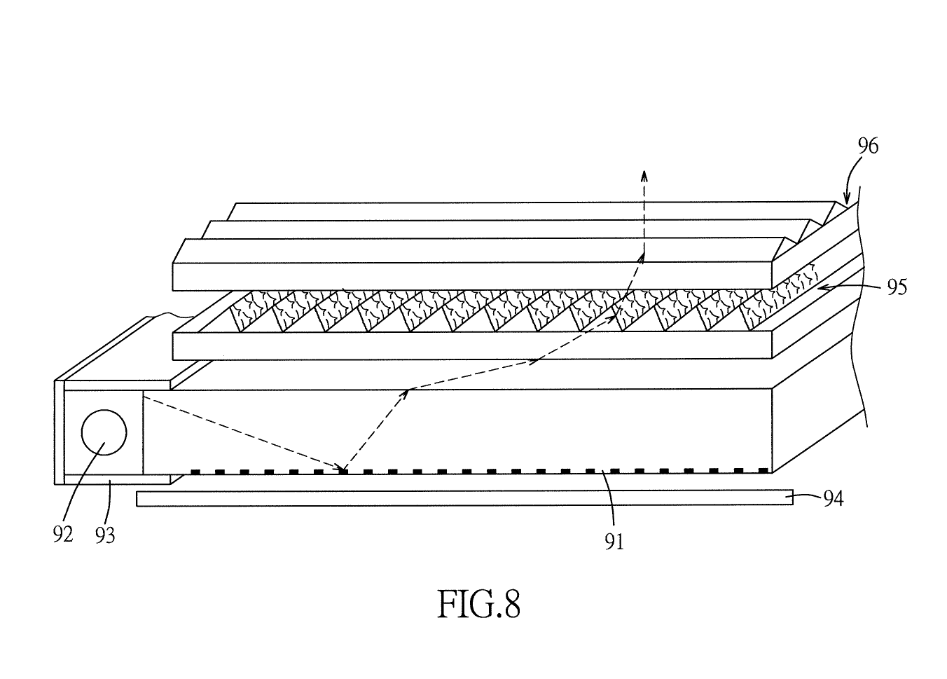

FIG. 8 illustrates the configuration of a backlight module according to the present disclosure. The backlight module includes a light guide plate 91, a light source 92 mounted on one side of the light guide plate 91, a cover 93 covering the light source 92, a reflector 94 attached to a bottom side of the light guide plate 91, and lower and upper prism sheets 95, 96 that are stacked on the light guide plate 91. The lower prism sheet 95 has a structure the same as that of the first embodiment. The elongated prisms of the lower prism sheet 95 are perpendicular to those of the upper prism sheets 96. With the inclusion of the lower prism sheet 95 in the backlight module of the present disclosure, the bottom diffuser 51, the lower prism sheet 52 and the top diffuser 54 employed in the aforesaid conventional backlight module may be dispensed with without sacrificing the brightness and uniformity of light output from the backlight module to a display (not shown), and the aforesaid drawbacks, such as the aforesaid observable defects, may be alleviated.

While the invention has been described in connection with what are considered the exemplary embodiments, it is understood that this invention is not limited to the disclosed embodiments but is intended to cover various arrangements included within the spirit and scope of the broadest interpretation and equivalent arrangements.

What is claimed is:

1. An optical prism sheet comprising:
a transparent substrate having a light-entrance surface; and
a plurality of elongated prisms that are disposed at one side of said transparent substrate opposite to said light-entrance surface, that protrude from said transparent substrate in a direction away from said light-entrance surface, and that are substantially parallel to one another, each of said prisms having a scalene triangular cross-section and first and second surfaces that intersect each other to define an apex angle which is opposite to and faces toward said transparent substrate, said apex angle of each of said prisms being divided by a normal line of said transparent substrate into first and second sub-angles that are different from each other;
wherein at least one of said light-entrance surface and said first and second surfaces of each of said prisms is roughened to form a plurality of micro-protrusions, each of which has a height ranging from 0.1 μm to 5 μm.

2. The optical prism sheet of claim 1, wherein each of said first and second sub-angles ranges from 10 degrees to 50 degrees.

3. The optical prism sheet of claim 1, wherein said prisms are made from a UV-cured resin.

4. The optical prism sheet of claim 3, wherein said UV-cured resin has a refractive index ranging from 1.45 to 1.62.

5. The optical prism sheet of claim 1, wherein said first sub-angles of said prisms are larger than said second sub-angles of said prisms.

6. The optical prism sheet of claim 1, wherein said first surfaces of said prisms are parallel to one another, and said second surfaces of said prisms are parallel to one another.

7. The optical prism sheet of claim 6, wherein said apex angles of said prisms are equal.

8. The optical prism sheet of claim 1, wherein said transparent substrate is made from a polymeric material.

9. The optical prism sheet of claim 1, wherein at least said first and second surfaces of each of said prisms is formed with said micro-protrusions.

10. The optical prism sheet of claim 1, wherein said light-entrance surface and said first and second surfaces of each of said prisms are formed with said micro-protrusions.

11. The optical prism sheet of claim 1, wherein said second surface of one of every two adjacent ones of said prisms and said first surface of the other of said every two adjacent ones of said prisms are connected to each other to form a V-shaped valley.

12. The optical prism sheet of claim 1, wherein said second surface of one of every two adjacent ones of said prisms and said first surface of the other of said every two adjacent ones of said prisms are connected to each other to form a U-shaped concave valley.
